(19) United States
(12) Patent Application Publication
(10) Pub. No.: US 2026/0293923 A1
(43) Pub. Date: Oct. 1, 2026

(54) DAIRY SUBSTITUTE COMPRISING MYCOPROTEIN

(71) Applicant: PLANETARY SA, Cologny (CH)

(72) Inventors: Muyiwa AKINTOYE, Guisborough Cleveland (GB); David BRANDES, Vesenaz (CH); Ian MARISON, Echandens (CH)

(21) Appl. No.: 19/490,073

(22) PCT Filed: Jun. 5, 2024
(86) PCT No.: PCT/EP2024/065410

§ 371 Date: Dec. 4, 2025

(30) Foreign Application Priority Data
Jun. 5, 2023 (EP) 23177272.4

(51) Int. Cl. A23C 11/06; A23J 3/20; A23L 9/20

(52) U.S. Cl. CPC A23C 11/065; A23J 3/20; A23L 9/24

(57) ABSTRACT

The present invention relates to a dairy substitute comprising a mycoprotein source dispersed in water with high acyl gellan gum. Such dairy substitute is characterised by a texture and flavour close to a corresponding dairy product and by good physical stability, even when prepared without high pressure homogenisation. A process for producing such dairy substitute is also provided. The dairy substitute can advantageously be used to produce any food product that can be derived from a dairy product.

### TECHNICAL FIELD

The present invention relates to a dairy substitute comprising a mycoprotein source dispersed in water with high acyl gellan gum. Such dairy substitute is characterised by a texture and flavour close to a corresponding dairy product and by good physical stability, even when prepared without high pressure homogenisation. A process for producing such dairy substitute is also provided. The dairy substitute can advantageously be used to produce any food product that can be derived from a dairy product.

### BACKGROUND ART

There is a growing trend to recognise the negative impact of the dairy industry on climate and environment, due to high water consumption, heavy land use and carbon dioxide emissions caused by bovine breeding. As a result, several environmentally friendly alternatives to dairy products have been developed to solve this problem. In particular, milk substitutes based on plant proteins are now widespread and commercially available.

This growing global environment concern results in a growing trend to adopt a vegetarian or vegan diet. It is therefore desirable to provide new vegetarian and vegan formulations, to replace animal-based food products, such as dairy products.

Mycoprotein, in particular fungal mycelium, has also been previously used as alternatives to animal proteins. For example, WO2002/090527A1 discloses an aqueous formulation comprising edible fungal particles consisting substantially of fungal mycelia and having a maximum dimension of less than 200 μm. This particle size is achieved by subjecting the aqueous formulation to a size reduction process, such as homogenisation. The formulation is disclosed as useful in the preparation of foodstuffs, such as yoghurts, desserts or drinks. The formulations may comprise hydrocolloids (e.g. starch, pectin, carrageenan or alginate). The example of non-dairy milk (example 7) is produced by homogenisation at 14503 psi and comprises a mixture of pectin and carrageenan as stabiliser. It would be desirable to provide compositions that are stable even when produced with lower homogenisation pressures. This is advantageous to produce dairy substitutes with more environmentally friendly processes and saving energy.

WO2021/234348A1 discloses the preparation of a milk-like foodstuff and the examples comprise either 0.35 wt % pectin or 0.1 wt % gellan gum.

WO2022219170A1 discloses non animal dairy substitute products comprising fibrous mycelium with water. The general description teaches that the product may optionally comprise a texturising agent such as agar-agar, edible starch, guar gum, locust bean gum, wheat gluten, cellulose or derivatives thereof. Example 3, disclosing a non-animal milk, does not contain any texturising agent, unlike the yogurt and cheese examples. It would be further desirable to fine-tune mycelium-based formulations to improve stability, texture and/or flavour of such compositions.

The prior art therefore sets the basis for using aqueous dispersions of filamentous fungi and in particular mycelium as milk substitutes. It would be further desirable to fine-tune mycoprotein-based dairy substitutes, i.e. by providing dairy substitutes having adequate stability and having texture and flavour as close as possible to the sensory properties of corresponding dairy products, such as dairy milk.

It is an object of the present invention to fulfil all or part of the above-mentioned needs.

### BRIEF DESCRIPTION OF THE FIGURES

FIG. 1 is a graph showing the rating by the panel of the taste of Samples 1 to 11 produced in Example 1 and assessed in Example 2: sweet taste (black), umami taste (dark grey) and acid taste (light grey).

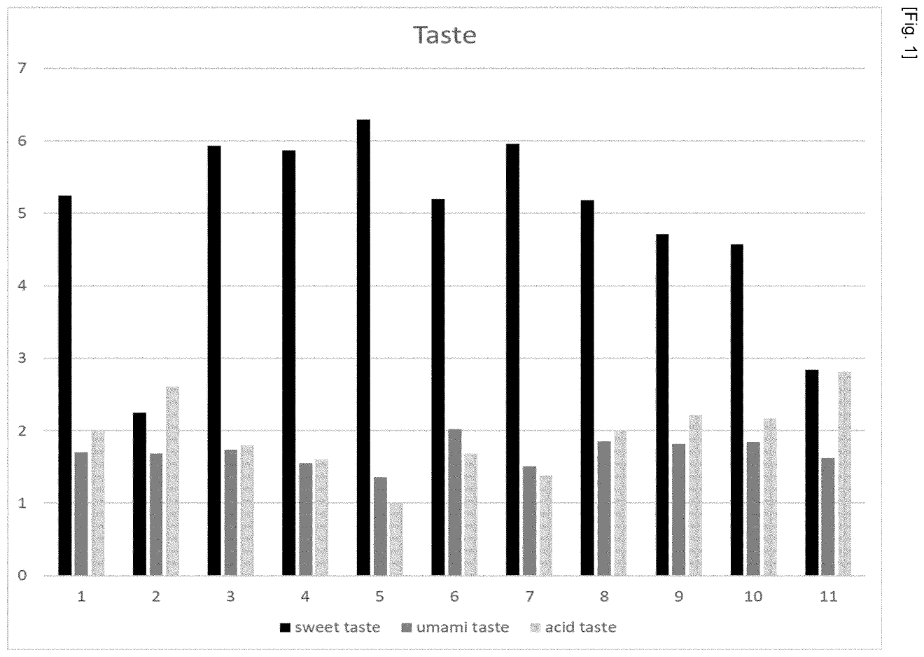

FIG. 2 is a graph showing the rating by the panel of the mouthfeel of Samples

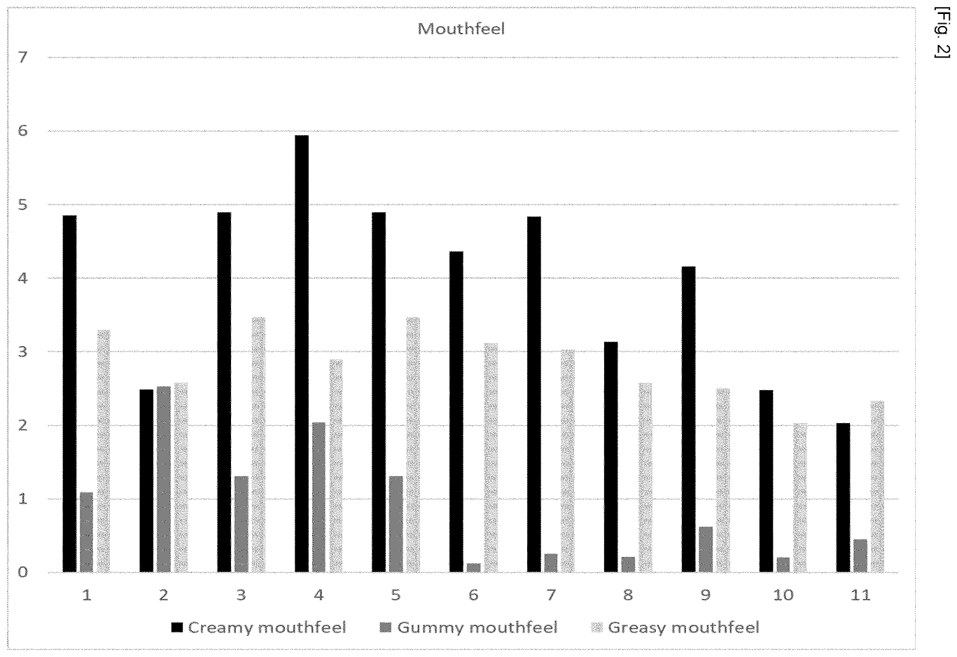

1 to 11 produced in Example 1 and assessed in Example 2: creamy mouthfeel (black), gummy mouthfeel (dark grey) and greasy mouthfeel (light grey).

FIG. 3 is a graph showing the rating by the panel of the flavour of Samples 1 to 11 produced in Example 1 and assessed in Example 2: milk flavour (black) and cream flavour (light grey).

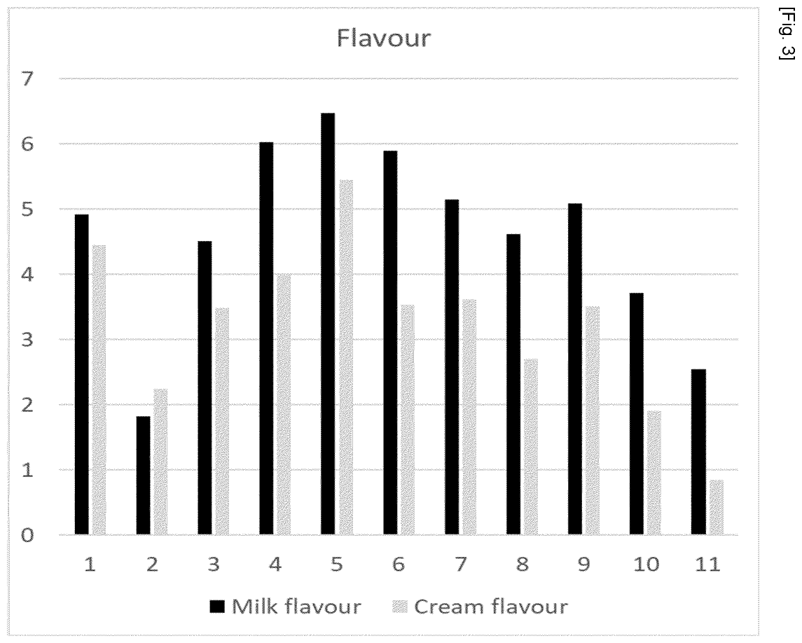

FIG. 4 is a graph showing the rating by the panel of the overall liking of Samples 1 to 11 produced in Example 1 and assessed in Example 2.

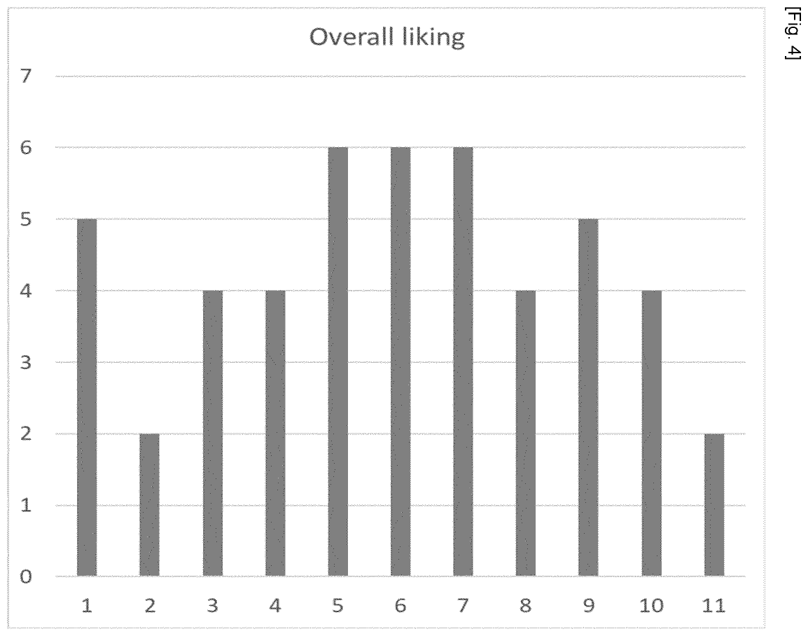

### SUMMARY OF INVENTION

In a first aspect, the present invention provides a dairy substitute comprising mycoprotein, water and high acyl gellan gum.

In a second aspect, the present invention provides a process for producing a dairy substitute comprising:
a) providing a mycoprotein source;
b) creating a slurry by dispersing the mycoprotein source in water and mixing until the slurry is uniform in consistency and fully dispersed, with no lumps visible to the naked eye;
c) adding high acyl gellan gum;
d) subjecting the mixture obtained at the end of step c) to a microfluidisation or homogenisation step at a constant pressure of less than 10000 psi;
e) activating high acyl gellan gum by heating the slurry to at least 72° C.;
f) subjecting the mixture to a second microfluidisation or homogenisation step at a constant pressure of less than 10000 psi; and
g) optionally pasteurising the composition obtained at the end of step d), wherein the stabiliser is a positively charged, hydrocolloid based, stabiliser.

In a third aspect, the invention provides a dairy substitute obtainable or obtained by the process of the invention.

In a fourth aspect, the present invention relates to a food product comprising the dairy substitute of the invention or derived from the dairy substitute of the invention.

In a fifth aspect, the present invention relates to the use of a dairy substitute of the invention for the manufacture of a food product.

### DETAILED DESCRIPTION

The present invention relates to a dairy substitute. By a “dairy substitute”, it is meant a dispersion comprising non-dairy proteins, and optionally non-dairy fat, dispersed in water, said dispersion having the appearance of a dairy product and providing a sensory experience upon consumption resembling that of a dairy product. The present dairy substitute is preferably vegetarian or vegan, as it can be based solely on fungal and vegetal ingredients. In a preferred aspect, the dairy substitute is a mycoprotein-based dairy substitute. By a “mycoprotein-based dairy substitute”, it is meant a dispersion comprising mycoproteins, and optionally non-dairy fat, dispersed in water, said dispersion having the appearance of a dairy product and providing a sensory experience upon consumption resembling that of a dairy product.

### Dairy Substitute

The dairy substitute of the present invention comprises a dispersion of mycoprotein in water, together with high acyl gellan gum. In a preferred aspect, the dairy substitute of the present invention is selected from a milk substitute, a cream substitute or a yogurt substitute.

High acyl gellan gum is commercially available and is defined as a water-soluble polysaccharide having the following formula:

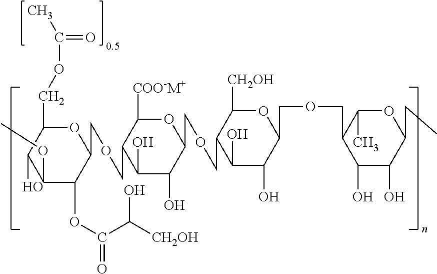

In a preferred aspect, the dairy substitute does not contain any other polysaccharide, in addition to high acyl gellan gum and any polysaccharide provided by the mycoprotein source. In particular, the present dairy substitute preferably does not contain any additional thickener or colloidal stabiliser.

In a preferred aspect, high acyl gellan gum is present in an amount of 0.005 to 0.075 wt %, preferably 0.008 to 0.06 wt %, more preferably 0.008 to 0.05 wt %, more preferably 0.008 to 0.03 wt %, more preferably 0.008 to 0.02 wt %, most preferably 0.01 to 0.2 wt %, based on the total weight of the dairy substitute. Such amounts are particularly advantageous in that the dairy substitute is stable and is characterised by an appropriate texture mimicking dairy products. Smaller concentrations are insufficient to stabilise the compositions and provide a texture that is too watery. Higher concentrations cause instability (by way of phase separation and/or thickening) of the composition when heated.

In another preferred aspect, the dairy substitute further comprises oil and preferably also an emulsifier. Oil is an optional component of the dairy substitute of the present invention, because the presence of high acyl gellan gum provides an appropriate texture even in the absence of oil, which makes it possible to make a low energy content, fat free or low-fat dairy substitute having good sensory properties. Low fat dairy substitutes with concentrations of high acyl gellan gum below 0.05 wt %, preferably of up to 0.03 wt %, more preferably of up to 0.02 wt % are advantageously characterised by a less gummy mouthfeel than those with a higher concentration of stabiliser.

The amount of oil is adapted, depending on the dairy substitute type and is preferably of up to 3.5 wt %, preferably 0.5 to 3.5 wt %, preferably 0.5 to 3 wt %, more preferably 0.7 to 3.0 wt %, even more preferably 0.8 to 3 wt %, most preferably 0.9 to 2.9 wt %, based on the total weight of the dairy substitute. Amounts towards the upper limit of the range, i.e. of 1 to 3.5 wt %, preferably 1.5 to 3.5 wt %, more preferably 2 to 3 wt %, even more preferably 2.5 to 3 wt %, based on the total weight of the dairy substitute, are characterised by a sweeter taste than dairy substitutes with lower amounts of oil and are further characterised by strong milk and cream flavour.

The oil is preferably a vegetable oil, such as sunflower oil, rapeseed oil, palm oil, soybean oil, coconut oil, corn oil, cottonseed oil, olive oil, safflower oil, or a nut-derived oil. Preferably it is sunflower oil, rapeseed oil, palm oil, coconut oil, cottonseed oil, olive oil or safflower oil. These oils are advantageously sourced from plants that have lower allergenicity. More preferably, it is sunflower oil, rapeseed oil, coconut oil, or safflower oil. These oils are advantageously characterised by a relatively neutral taste and flavour, allowing to obtain a dairy substitute having sensory properties closer to dairy milk. Most preferably it is sunflower oil or rapeseed oil. These oils are advantageously characterised by a particularly reasonable life cycle environmental impact compared to other oils.

When the dairy substitute comprises oil, it preferably also comprises an emulsifier. Such emulsifier is preferably selected from lecithin and mono- and di-saccharides. Lecithin is particularly preferred, because it contributes to the stability of the emulsion and is also more beneficial to the stability of the protein dispersion, compared to other emulsifiers. The presence of the emulsifier makes it possible also to make products with lower amounts of mycoprotein. The emulsifier is preferably present in an amount of 0.025 to 0.2 wt %, preferably 0.03 to 0.25 wt %, more preferably 0.04 to 0.2 wt %, even more preferably 0.05 to 0.15 wt %, based on the total weight of the dairy substitute.

In another particular aspect, the particle size of the dispersion is of more than 10 to 70 μm, preferably of more than 10 to 60 μm, more preferably of more than 10 to 50 μm, even more preferably of more than 10 to 40 μm, most preferably of more than 10 to 30 μm or even more than 10 to 25 μm. Preferably, the dispersion is a colloidal dispersion.

The particle size is defined as the mean diameter, defined by weight, as determined by dynamic light scattering. The particle size is advantageously characterized by a narrow particle size distribution. This narrow particle size distribution is beneficial to the stability of the dispersion and to the sensory properties of the product. For example, a broad dispersion would include coarser particles that tend to separate and could even be perceived by the consumer and impair the sensory properties, such as mouthfeel and smoothness of the product.

The particle size as recited herein is advantageously providing smoothness to the product in the mouth. Smoothness is in turn associated with creamy mouthfeel, which is very much sought for dairy substitute products such as presently claimed.

The present inventors have fine-tuned the type and amount of stabiliser adequate for stabilising a dairy substitute having the above-described particle size distribution and have found that high acyl gellan gum was particularly effective in providing physical stability to the dairy substitute. Indeed, despite a rather large particle size, the dairy substitute of the invention is physically stable, i.e., does not sediment, preferably for a period of at least 2 hours at 5° C. or even up to 7 days at 2 to 10° C. The stabilisation is provided by high acyl gellan gum, as will be shown in the examples below. Without limiting the invention to a particular mechanism, high acyl gellan gum is believed to interact with the proteins and effectively prevents aggregation of the proteins and, in turn, sedimentation. The stabilisation of a mycoprotein-based formulation having the above-mentioned particle size is beneficial because it makes it possible to use smoother processing conditions, in particular low pressure microfluidisation or homogenisation, which consumes less energy and is therefore more environmentally friendly compared to processing at higher pressures.

In a particular aspect of the invention, the dairy substitute is a milk substitute. Such milk substitute is preferably characterised by a high acyl gellan gum content of 0.005 to 0.02 wt %, preferably of 0.0075 to 0.015 wt %, by an oil content of up to 2 wt %, preferably up to 1.5 wt %, more preferably up to 1 wt % and/or by an emulsifier content of 0.025 to 0.1 wt %, preferably 0.03 to 0.075 wt %, more preferably 0.04 to 0.06 wt %, based on the total weight of the milk substitute.

In another particular aspect of the invention, the dairy substitute is a cream substitute. Such cream substitute is preferably characterised by a high acyl gellan gum content of 0.015 to 0.075 wt %, preferably of 0.015 to 0.05 wt %, more preferably 0.015 to 0.03 wt %, by an oil content of 1 to 3.5 wt %, preferably 2 to 3 wt %, and/or by an emulsifier content of 0.075 to 0.2 wt %, preferably 0.1 to 0.2 wt %, based on the total weight of the cream substitute.

In still another particular aspect of the invention, the dairy substitute is a yogurt. Such yogurt substitute is preferably characterised by a high acyl gellan gum content of 0.015 to 0.075 wt %, preferably of 0.015 to 0.05 wt %, more preferably 0.015 to 0.03 wt %, based on the total weight of the yogurt substitute and preferably comprises mono- and di-glycerides as emulsifier. In a more preferred aspect, the oil content is of up to 2 wt %, preferably up to 1.5 wt %, more preferably up to 1 wt %, based on the total weight of the yogurt substitute. In another preferred aspect, the emulsifier content in the yogurt substitute is of 0.025 to 0.1 wt %, preferably 0.03 to 0.075 wt %, more preferably 0.04 to 0.06 wt %, based on the total weight of the yogurt substitute.

In another particular aspect of the invention, the dairy substitute is low-fat dairy substitute comprising less than 2 wt %, preferably less than 1.5 wt %, more preferably less than 1 wt % of oil, based on the total weight of the dairy substitute, most preferably no oil. Such low-fat dairy substitute preferably comprises high acyl gellan gum in an amount of 0.005 to less than 0.02 wt %, preferably of 0.005 to 0.015 wt %, more preferably of 0.0075 to 0.015 wt %, based on the total weight of the low-fat dairy substitute. Low-fat dairy substitutes having higher amounts of high acyl gellan gum are less preferred, because bitter and metallic off notes are more perceptible. This is particularly true when no oil is present. The formulation of the present invention is therefore advantageous because it is physically stable even with stabiliser amounts sufficiently low to avoid imparting any undesirable off-note to the product. Indeed, high acyl gellan gum can be used in amounts sufficiently low to be sensory neutral to the consumer.

In a particular aspect, the solids to water ratio of the dairy substitute is in the range of 1:4 to 1:40.

In a preferred aspect, the dairy substitute is characterised by a viscosity at 10° C. of 1 to 200 cP, preferably 1-180 cP, more preferably 37-200 cP, more preferably 37 to 185 cP or 37 to 175 cP, such as 57 to 200 cP, 57 to 180 cP, 57 to 175 or 70 to 200 cP, 70 tp 180 cP or 10 to 175 cP, to provide a product with high viscosity or 1 to less than 20 cP, preferably 1 to 16 cP, more preferably 1 to 12 cP, or preferably 2 to less than 20 cP, preferably 2 to 16 cP. For a milk substitute, the viscosity is preferably in the range of 1 to 5 cP, preferably 1 to 3 cP, more preferably 2 to 3 cP at 10° C. For a cream substitute, the viscosity is preferably in the range of 6 to 20 cP, preferably 6 to 16 cP, more preferably 8 to 16 cP at 10° C., to mimic the viscosity of cow milk. The viscosity is preferably measured by a rotational viscometer or a controlled stress rheometer, preferably a rotational viscometer, such as using a Brookfield rotational viscometer set up to measure in centipoise or using an Anton Paar controlled stress rheometer (Anton Paar, Austria) using a parallel plate geometry.

This viscosity is an important parameter that contributes, with the particle size distribution, to the advantageous sensory properties of the formulation. This viscosity range is advantageously closer to dairy milk and cream viscosities than the prior art mycelium aqueous dispersions. Indeed, the viscosity at 10° C. of dairy milk is typically between 2 and 3 cP, depending on the fat content, that of dairy single cream is typically between 8 and 12 cP and that of dairy double cream is typically between 12 and 16 cP. The optimal viscosity of the dairy substitutes of the present invention results from the combination of the low pressure microfluidisation or homogenisation step and of the use of high acyl gellan gum, preferably in amounts such as described above. Indeed, as will be shown in the examples below, high acyl gellan gum is advantageous in that imparts a higher viscosity to the dairy substitute than other conventional stabilisers or thickeners, such as low acyl gellan gum, guar gum and gum acacia.

The solids to water ratio in the dairy substitute is preferably of 1:12 to 1:32. The solids to water ratio typically varies depending on the product type. Preferably, in the case of a milk substitute, the solids to water ratio is 1:24 to 1:40, preferably 1:24 to 1:36, more preferably 1:28 to 1:32. In another aspect, in the case of a cream substitute, the solids to water ratio is 1:4 to 1:20, preferably 1:8 to 1:20, more preferably 1:12 to 1:16.

In particular aspects of the invention, the protein content in the dairy substitute is of 0.9 to 3 wt %, such as 1.5 to 2.5 wt %, based on the total weight of the dairy substitute.

The mycoprotein source is preferably in the form of a filamentous fungus or of a fungal mycelium. Preferably, it is a filamentous fungus or a fungal mycelium belonging to a division selected from the group consisting of Blastocladiomycota, Chytridiomycota, Glomeromycota, Microsporidia, Neocallimastigomycota, Dikarya, Ascomycota, Pezizomycotina, Saccharomycotina, Taphrinomycotina, Basidiomycota, Agaricomycotina, Pucciniomycotina, Ustilaginomycotina, Entomophthoromycotina, Mucor and Kickomycotina. Preferably the filamentous fungus or fungal mycelium belongs to a family selected from the group consisting of Mucoraceae, Ustilaginaceae, Hericiaceae, Polyporaceae, Grifolaceae, Lyophyllaceae, Strophariaceae, Lycoperdaceae, Agaricaceae, Pleurotaceae, Physalacriaceae, Omphalotaceae, Tuberaceae, Morchellaceae, Sparassidaceae, Nectriaceae, Bionectriaceae, Cordycipitaceae, Incertomyae, Meruliaceae, Entolomataceae, Nidulariaceae, Fomitopsidaceae, Phanerochaetaceae, Mycenaceae. Preferably it belongs to a genus selected from Rhizopus, Ustilago, Hericululm, Polyporous, Grifola, Hypsizygus, Calocybe, Pholiota, Calvatia, Agaricus, Stropharia, Hypholoma, Pleurotus, Tuber, Morchella, Sparassis, Fusarium, Disciotis, Clonostachys, Cordyceps, Trametes, Ganoderma, Flammulina, Lentinula, Lucoagaricus, Bjerkandera, Clitopilus, Cyathus, Ischnoderma, Kuehneromyces, Letinula, Lentinus, Macrofungus, Marasmius, Nidula, Ossicaulis, Phanerochaetes, Ossicaulis, Panellus, Postia, Pycnoporus, Tyromyces, Wolfiporia. More preferably, it belongs to a species selected from Rhizopus oligosporus, Ustilago esculenta, Hericululm erinaceus, Polyporous squamosus, Polyporus melanopus, Grifola fondrosa, Hypsizygus marmoreus, Hypsizygus ulmarius, Calocybe gambosa, Pholiota nameko, Calvatia gigantea, Agaricus bisporus, Stropharia rugosoannulata, Hypholoma lateritium, Hypholoma capnoides, Pleurotus eryngii, Pleurotus ostreatus, Pleurotus citrinopiheatus, Pleurotus ostreatus, var. Columbinus, Pleurotus djamor roseus, Pleurotus sapidus, Pleurotus sp. florida, Tuber borchii, Morchella esculenta, Morchella conica, Morchella importuna, Sparassis crispa, Fusarium venenatum, Fusarium oxysporum, Disciotis venosa, Clonostachys rosea, Cordyceps militaris, Trametes versicolor, Ganoderma lucidum, Ganoderma applanatum, Flammulina velutipes, Lentinula edodes, Pleurotus djamor, Pleurotus ostreatus, Lucoagaricus spp., Bjerkandera adusta, Clitopilus passeckerianus, Cyathus helenae, Ischnoderma benzoinum, Kuehneromyces mutabilis, Letinula edodes, Lentinus squarrosulus, Macrofungus cohortalis, Marasmius scorodonius, Marasmius scorodonius, Nidula niveo-tomentosa, Phanerochaete chrysosporium, Ossicaulis lignatilis, Panellus serotinus, Postia caesia, Pycnoporus sanguineus, Tyromyces chioneus, Wolfiporia cocos.

The most preferred genus for the purpose of the present invention is Fusarium, and preferred species is Fusarium venenatum.

The dairy substitute optionally comprises other ingredients such as carbohydrates, sweeteners, flavours, salt, hydrocolloids, spices, vitamins, minerals, preservatives, colorants, and the like.

The carbohydrate is preferably at least one sugar, such as sucrose, fructose, dextrose, maltose, arabinose or galactose and the like, or a sugar rich composition, such as corn syrup, agave syrup and the like. Such carbohydrate is preferably present in the dairy substitute as a replacement of the lactose naturally present in dairy milk. Sugars also contributes to the pleasant texture and aroma of the dairy substitute. Preferably it is sucrose, fructose, dextrose, maltose or arabinose. Most preferably it is sucrose or fructose. The carbohydrate is preferably in the form of white sugar or cane sugar. Sweeteners are typically used instead of sugar in low calories milk substitutes.

Flavours are preferably present in the dairy substitute, because it significantly improves the sensory properties of the substitute, making it more similar to dairy milk. The flavour is preferably a milk flavour. More preferably, the flavour is a vegan milk flavour. Other types of flavours can be added, in view of preparing a flavoured dairy substitute, such as a fruit flavoured dairy substitute.

Salt is preferably present and acts as a flavour and taste enhancer.

Colorants, may also be added to improve the appearance of the dairy substitute and to better mimic dairy products, such as milk, cream or yogurt.

The dairy substitute may optionally be fortified with nutrients, such as vitamins and minerals, such as to provide additional health benefits to the consumer. For specific nutritional applications, it may therefore be useful to fortify the dairy substitute with further minerals and/or vitamins. These nutrients are well-known to the person skilled in the art, and can be added in any suitable amount, in view of the desired health benefit and/or of the needs of the targeted consumer population.

Preservatives, such as antibacterial or antifungal agents and antioxidants can be present to avoid spoilage of the dairy substitute. Antibacterial or antifungal agents disable the growth of bacteria and mould in the product over time and significantly increase the shelf life of the dairy substitute. An antifungal agent does not harm the product quality, as the dispersion does not contain any live fungi. For example, suitable antibacterial or antifungal agents include benzoates, sorbates, propionates, nitrites. Antioxidants reduce oxidation of the nutrients contained in the dairy substitute and contributes to maintaining the nutritional quality, appearance and taste of the product over time, thus also increasing the shelf life. Suitable antioxidants include sulfites, such as sodium sulfite, sodium bisulfite, sodium metabisulfite, potassium bisulfite and potassium metabisulfite, tocopherol (vitamin E), ascorbic acid (vitamin C), butylated hydroxyanisole, butylated hydroxytoluene or chelating agents, such as disodium ethylenediaminetetraacetic acid (EDTA), polyphosphates, or citric acid.

### Process and Product-by-Process

The process of the present invention for producing a dairy substitute comprises the following steps:
a) providing a mycoprotein source;
b) creating a slurry by dispersing the mycoprotein source in water and mixing until the slurry is uniform in consistency and fully dispersed, with no lumps visible to the naked eye;
c) adding high acyl gellan gum;
d) activating high acyl gellan gum by heating the slurry to at least 72° C.;
e) subjecting the mixture to a second microfluidisation or homogenisation step at a constant pressure of less than 10000 psi; and
f) subjecting the mixture obtained at the end of step c) to a microfluidisation or homogenisation step at a constant pressure of less than 10000 psi; and
g) optionally pasteurising the composition obtained at the end of step d).

The amounts of high acyl gellan gum to be used are as defined above in the section related to the dairy substitute.

In a particular aspect of the invention, an oil and an emulsifier are further added in step c. The oil, the emulsifier and the amounts of these ingredients to be used are as defined above in the section related to the dairy substitute.

The mycoprotein source is preferably a filamentous fungus or a fungal mycelium, such as defined above in the section related to the dairy substitute.

The mycoprotein source can be provided in the form of a fresh or frozen biomass, or as a dried powder. If it is in the form of a frozen biomass, the mycoprotein source is preferably defrosted, more preferably using steam.

The mycoprotein source is preferably washed before being processed further. The washing step is preferably performed by resuspending the mycoprotein source in water and removing the water, preferably at least two, more preferably at least three times. This step allows to remove any impurities that would be present in the mycoprotein source and contributes to the removal of the savoury taste elements of the mycoprotein source, by eliminating a range of molecules and minerals.

The mycoprotein source is preferably admixed with water at a solids to water ratio of 1:4 to 1:40 and a slurry is formed. The solids to water ratio is advantageous to obtain a composition sufficiently dilute, such that it can be efficiently subjected to microfluidisation or homogenisation.

The slurry is formed by any method known to the person skilled in the art for making a protein slurry. Typically, the mycoprotein source is mixed with water by any suitable means, such as to remove any lumps of the mycoprotein source. Preferably, the slurry is mixed at high speed. This is advantageous as it makes the microfluidisation or homogenisation step d) more efficient and contributes to reduction of the particle size and to the stability of the product.

In a preferred aspect, the slurry is heated to remove any astringency and to improve the taste and/or aroma of the dairy substitute.

All other ingredients of the dairy substitute are then added simultaneously or sequentially to the slurry. These ingredients include high acyl gellan gum and optionally the oil and the emulsifier. Any other optional ingredient such as disclosed above in the section related to the dairy substitute is also added at this stage.

These ingredients can advantageously be added all at once to the slurry and be directly subjected to the microfluidisation or homogenisation step. The use of microfluidisation or homogenisation in step d) advantageously enables the addition of all ingredients at the same time to the mycoprotein slurry. It also efficiently disperses the proteins and, when present, the oil, in the aqueous continuous phase.

In step d), the slurry of mycoprotein, high acyl gellan gum and any optional ingredient in water is admixed and homogenised by a microfluidisation or homogenisation step at a pressure of less than 10000 psi, preferably 1000 to 8000 psi, more preferably 1500 to 6000 psi, even more preferably 2000 to 5000 psi, even more preferably 3000 to 4000 psi. At lower pressures, the dispersion of the protein and, when present, the oil is sub-optimal. Higher pressures involve high energy consumption, which is not desirable and not necessary to obtain a stable product. Indeed, the presence of high acyl gellan gum compensates for the larger particles generated by the relatively low pressures used in the present invention, thus leading to a dairy substitute that is stable and produced in more environmentally friendly manner.

The homogenisation or microfluidisation step advantageously reduces the size of mycelium hyphae and at the same time disperses oil, if present.

After the first microfluidisation or homogenisation step, the mixture is heated to a temperature of more than 72° C. in step e), such as to activate the stabiliser. This step is essential to obtain the desired modification in viscosity and stabilisation of the dairy substitute.

Step e) also serves as a pasteurisation step. Provided that contamination is avoided in the next steps, no further pasteurisation step is necessary.

After activation of high acyl gellan gum, a second microfluidisation or homogenisation step f) is performed at a pressure of less than 10000 psi. This second microfluidisation or homogenisation step is essential to achieve the desired particle size and viscosity. Performing the second microfluidisation or homogenisation step after activation of high acyl gellan gum is particularly advantageously, because any larger particle formed during the activation of high acyl gellan gum, such as high acyl gellan gum lumps and/or agglomerates of high acyl gellan gum with the protein, is broken up by the microfluidisation or homogenisation, ensuring homogeneous texture of the product.

The viscosity after the second microfluidisation or homogenisation step typically exhibits a 10-fold reduction, which results from a significant break-up of hyphae present in the mycoprotein source. Microfluidisation and homogenisation advantageously do not impact the pH of the mycoprotein slurry.

In optional step g) of the present process, the dispersion obtained at the end of the second microfluidisation or homogenisation step is pasteurised. This step is useful in case contamination may have happened during the second microfluidisation or homogenisation step. In case the set-up of step f) is such that contamination is exclude, step g) can be omitted. Any pasteurisation method can be used. Pasteurisation techniques are well known to the person skilled in the art. In a preferred aspect, the pasteurisation is performed by heating to a temperature of 72° C., holding for about 60s and then rapidly cooling down to 4° C.

The dispersion may then be packaged in any suitable way. Preferably it is hot filled into containers using standard filling methods known in the art and then cooled down and stored to 4° C.

Alternatively, the dispersion may be dried, for example by spray-drying or freeze-drying and filed into containers suitable for powders.

In a particular aspect, the present invention provides a dairy substitute obtained or obtainable by the process described above.

### Food Products

The dairy substitute of the present invention can advantageously be used in any food product that is commonly derived from a dairy product or comprises a dairy product. Therefore, the present invention also relates to a food product comprising a mycelium-based dairy substitute according to the present invention. Examples of food products include a dessert, a mousse, a cheese spread, a cheese (such as a creamy or hard cheese), an ice-cream, a custard, a porridge, a pudding, a smoothie, a chocolate, an infant formula, a toddler formula and a growing-up milk.

Food products of the invention comprising the dairy substitute of the invention or derived from the dairy substitute of the present invention can be prepared in the same way as corresponding food products comprising or derived from an animal dairy product, such as milk, cream, or yogurt, by simply replacing in whole or in part the animal dairy product by the dairy substitute of the present invention.

In a preferred aspect, the food product comprising the dairy substitute of the present invention or derived from the dairy substitute of the present invention does not comprise any dairy product of animal origin.

### EXAMPLES

### Example 1: Preparation of Dairy Substitutes According to the Invention

Dairy Substitutes 1 to 9 according to the invention, and comparative Dairy Substitutes 10 and 11 were prepared, having the composition described in [Table 1A], [Table 1B] and [Table 1C] below.

TABLE 1A

| | Sample 1 [%] | Sample 2[%] | Sample 3 [%] | Sample 4 [%] |
|---|---|---|---|---|
| Ingredient | (Invention) | (Invention) | (Invention) | (Invention) |
| Mycoprotein | 10.91 | 16.33 | 16.16 | 16.16 |
| source | | | | |
| Water | 86.51 | 82.05 | 81.21 | 81.21 |
| Sugar | 0.97 | 0.98 | 0.97 | 0.97 |
| Salt | 0.10 | 0.10 | 0.10 | 0.10 |
| Flavour | 0.49 | 0.49 | 0.49 | 0.49 |
| Oil | 0.97 | 0.00 | 0.97 | 0.97 |
| High acyl | 0.05 | 0.05 | 0.05 | 0.05 |
| gellan gum | | | | |
| Lecithin | 0.00 | 0.00 | 0.05 | 0.00 |
| Guar gum | 0.00 | 0.00 | 0.00 | 0.00 |
| Mono- and di- | 0.00 | 0.00 | 0.00 | 0.05 |
| saccharides | | | | |
| (silk gel) | | | | |
| Total | 100.00 | 100.00 | 100.00 | 100.00 |

TABLE 1B

| | Sample 5 | Sample 6 | Sample 7 | Sample 8 | Sample 9 |
|---|---|---|---|---|---|
| | [%] | [%] | [%] | [%] | [%] |
| Ingredient | (Invention) | (Invention) | (Invention) | (Invention) | (Invention) |
| Mycoprotein | 10.69 | 10.91 | 10.69 | 11.02 | 10.91 |
| source | | | | | |
| Water | 84.75 | 86.50 | 84.76 | 87.38 | 86.49 |
| Sugar | 0.95 | 0.97 | 0.95 | 0.98 | 0.97 |
| Salt | 0.10 | 0.10 | 0.10 | 0.10 | 0.10 |
| Flavour | 0.48 | 0.49 | 0.48 | 0.49 | 0.49 |
| Oil | 2.86 | 0.97 | 2.86 | 0.00 | 0.97 |
| High acyl | 0.02 | 0.01 | 0.01 | 0.02 | 0.02 |
| gellan gum | | | | | |
| Lecithin | 0.14 | 0.05 | 0.14 | 0.00 | 0.00 |
| Guar gum | 0.00 | 0.00 | 0.00 | 0.00 | 0.00 |
| Mono- and di- | 0.00 | 0.00 | 0.00 | 0.00 | 0.05 |
| saccharides | | | | | |
| (silk gel) | | | | | |
| Total | 100.00 | 100.00 | 100.00 | 100.00 | 100.00 |

TABLE 1C

| | Sample 10 | Sample 11 |
|---|---|---|
| | [%] | [%] |
| Ingredient | (comparative) | (comparative) |
| Mycoprotein | 11.02 | 11.02 |
| source | | |
| Water | 87.40 | 87.40 |
| Sugar | 0.98 | 0.98 |
| Salt | 0.10 | 0.10 |
| Flavour | 0.49 | 0.49 |
| Oil | 0.00 | 0.00 |
| High acyl | 0.00 | 0.00 |
| gellan gum | | |
| Lecithin | 0.00 | 0.00 |
| Guar gum | 0.00 | 0.02 |
| Mono- and di- | 0.00 | 0.00 |
| saccharides | | |
| (silk gel) | | |
| Total | 100.00 | 100.00 |

The mycoprotein was provided in the form of wet biomass of Fusarium venenatum pre-washed and was added to water, premixed by hand, and then with a stick blender or food blender. The liquid other ingredients (i.e. the liquid flavour, and when present, the oil) were added and blended using the sick blender or food blender until a smooth dispersion is obtained (about 60s). The other ingredients in solid form (i.e. the sugar, salt, the stabiliser and, when present the emulsifier) were sprinkled and premixed using the stick blender or food blender until fully dispersed (about 60s).

The microfluidiser was cleaned, sanitised, primed with water, then the other ingredients were introduced into the receptacle. The pressure was set to 3500 psi and the product was passed once. The microfluidiser effluent was heated in a pan on a hob to a temperature of at least 80° C. and then cooled rapidly by pouring into a second container in a cold water bath. When a temperature of less than 40° was reached, the product was microfluidised a second time at a pressure of 3500 psi. The effluent samples were filled into containers and placed in the fridge.

### Example 2: Comparison of the Properties of the Samples Prepared in Example 1 (Invention and Comparative)

The particle size and the viscosity of all samples was measured. The stability of each sample was also assessed. The formulations were let to stand at a temperature of 2° C. for 5 hours and the presence of sedimentation was assessed visually.

Furthermore, the sensory attributes of each sample were assessed. The creamy mouthfeel, greasy mouthfeel, gummy mouthfeel, sweet taste, umami taste, acid taste, milk flavour, cream flavour and overall liking were assessed by a trained panel of 10 panellists and rated on a scale ranging from 1 to 10. The mean ratings are provided for each sample was calculated.

All results are provided in [Table 2A], [Table 2B] and [Table 2C] below.

TABLE 2A

| | Sample 1 [%] | Sample 2[%] | Sample 3 [%] | Sample 4 [%] |
|---|---|---|---|---|
| Ingredient | (Invention) | (Invention) | (Invention) | (Invention) |
| Mean particle | 13.9 | 15.5 | 15.7 | 64.3 |
| size [μm] | | | | |
| Volume of | 5 | 5 | 5 | 3 |
| particles <10 μm | | | | |
| [%] | | | | |
| Volume of | 0 | 0 | 0 | 3 |
| particles >10 μm | | | | |
| [%] | | | | |
| Viscosity (cP) | 94.0 | 144,7 | 141.6 | 173.8 |
| Mean creamy | 4.85 | 2.49 | 4.89 | 5.94 |
| mouthfeel rating | | | | |
| Mean greasy | 3.30 | 2.58 | 3.47 | 2.90 |
| mouthfeel rating | | | | |
| Mean gummy | 1.09 | 2.53 | 1.31 | 2.04 |
| mouthfeel rating | | | | |
| Mean sweet | 5.24 | 2.25 | 5.93 | 5.87 |
| taste rating | | | | |
| Mean umami | 1.70 | 1.68 | 1.74 | 1.55 |
| taste rating | | | | |
| Mean acid taste | 1.99 | 2.61 | 1.80 | 1.60 |
| rating) | | | | |
| Mean milk | 4.92 | 1.82 | 4.51 | 6.02 |
| flavour rating | | | | |
| Mean cream | 4.45 | 2.24 | 3.48 | 3.99 |
| flavour rating | | | | |
| Mean overall | 5 | 2 | 4 | 4 |
| liking | | | | |
| Presence of | no | no | no | no |
| sedimentation | | | | |

TABLE 2B

| | Sample 5 | Sample 6 | Sample 7 | Sample 8 | Sample 9 |
|---|---|---|---|---|---|
| | [%] | [%] | [%] | [%] | [%] |
| Ingredient | (Invention) | (Invention) | (Invention) | (Invention) | (Invention) |
| Mean particle | 36.1 | 45.5 | 35.1 | 40.3 | 58.3 |
| size [μm] | | | | | |
| Volume of | 3.5 | 3.5 | 3.0 | 3.7 | 3.5 |
| particles <10 | | | | | |
| μm [%] | | | | | |
| Volume of | 2.5 | 2.5 | 2.5 | 2.3 | 2.8 |
| particles >10 | | | | | |
| μm [%] | | | | | |
| Viscosity (cP) | 37 | 51 | 37 | 42 | 71 |
| Mean creamy | 4.89 | 4.36 | 4.84 | 3.13 | 4.16 |
| mouthfeel | | | | | |
| rating | | | | | |
| Mean greasy | 3.47 | 3.12 | 3.03 | 2.58 | 2.50 |
| mouthfeel | | | | | |
| rating | | | | | |
| Mean gummy | 1.31 | 0.12 | 0.25 | 0.21 | 0.62 |
| mouthfeel | | | | | |
| rating | | | | | |
| Mean sweet | 6.29 | 5.20 | 5.96 | 5.18 | 4.71 |
| taste rating | | | | | |
| Mean umami | 1.36 | 2.02 | 1.51 | 1.85 | 1.82 |
| taste rating | | | | | |
| Mean acid | 1.00 | 1.68 | 1.38 | 2.01 | 2.21 |
| taste rating) | | | | | |
| Mean milk | 6.47 | 5.89 | 5.14 | 4.62 | 5.09 |
| flavour rating | | | | | |
| Mean cream | 5.45 | 3.53 | 3.61 | 2.70 | 3.51 |
| flavour rating | | | | | |
| Mean overall | 6 | 6 | 6 | 4 | 5 |
| liking | | | | | |
| Presence of | no | no | no | no | no |
| sedimentation | | | | | |

TABLE 2C

| | Sample 10 | Sample 11 |
|---|---|---|
| | [%] | [%] |
| Ingredient | (Comparative) | (Comparative) |
| Mean particle | 35.9 | 44.1 |
| size [μm] | | |
| Volume of | 4.0 | 3.5 |
| particles <10 μm | | |
| [%] | | |
| Volume of | 2.0 | 2.5 |
| particles >10 μm | | |
| [%] | | |
| Viscosity (cP) | 27 | 37 |
| Mean creamy | 2.48 | 2.03 |
| mouthfeel rating | | |
| Mean greasy | 2.03 | 2.33 |
| mouthfeel rating | | |
| Mean gummy | 0.20 | 0.45 |
| mouthfeel rating | | |
| Mean sweet | 4.57 | 2.84 |
| taste rating | | |
| Mean umami | 1.84 | 1.62 |
| taste rating | | |
| Mean acid taste | 2.17 | 2.81 |
| rating) | | |
| Mean milk | 3.71 | 2.54 |
| flavour rating | | |
| Mean cream | 1.90 | 0.84 |
| flavour rating | | |
| Mean overall | 4 | 2 |
| liking | | |
| Presence of | yes | yes |
| sedimentation | | |

### Discussion of the Results

Firstly, comparison of Sample 8 with Sample 10 demonstrates that the presence of high acyl gellan gum is essential to provide stability to the dairy substitute, as sample 8 (with high acyl gellan gum) was stable, whereas Sample 10 (with no stabiliser) did sediment within 2 hours at 5° C. Furthermore, comparison of Samples 8 and 11 demonstrates the surprising superiority of high acyl gellan gum over guar gum in terms of taste. Indeed, the sample with guar gum (Sample 11) had an acid taste almost as strongly perceived as the sweet taste, which is undesirable to mimic a dairy product, in particular milk or cream. In contrast, in Sample 8 with high acyl gellan gum, the sweet taste was much more strongly perceived than the acid taste.

Concentrations of high acyl gellan gum of 0.2 and 0.1 wt % proved advantageous over concentrations of 0.5 wt % because the gummy mouthfeel was less strongly perceived than in the samples with the lower concentrations of high acyl gellan gum (0.01 and 0.02 wt %). High acyl gellan gum concentration of 0.05 wt % was particularly disliked in the absence of oil and emulsifier, due to perception of gummy mouthfeel as stronger than creamy mouthfeel, making the product appear artificially thick. The stability of the samples with concentration of high acyl gellan gum of 0.01 and 0.02 wt %, was comparable to samples with 0.05 wt % of high acyl gellan gum. This demonstrate that the mouthfeel can be improved by using rather low amounts of high acyl gellan gum, without impairing the stability of the product.

Samples 5 and 7, comprising the highest amounts of oil were associated with the sweetest taste among the tested samples. These samples also exhibited strong milk and cream flavour, which demonstrate the positive impact of high oil concentrations on the flavour and taste of the dairy substitute.

Sample 8 had significantly better mouthfeel, taste and flavour than sample 2 and a good liking score of 4. This demonstrates that dairy substitutes with no fat can be produced with good sensory properties with amounts of high acyl gellan gum of 0.01 and 0.02 wt %. The same is observed with low amount of oil (0.97 wt %) as Sample 6 with 0.01 wt % of high acyl gellan gum had better sensory properties than Sample 3, which had 0.05 wt % high acyl gellan gum.

Samples 4 and 9, wherein mono- and di-saccharides were used as emulsifier had the largest particle size and were also thicker in texture than samples wherein the emulsifier was lecithin. These properties made the texture of these samples more appropriate for yogurt than for milk or cream application.

### Example 3: Preparation of Dairy Substitutes According to the Invention

Dairy Substitutes 10 and 11 according to the invention, and comparative Dairy Substitutes 12 to 19 were prepared, having the composition described in [Table 3A], [Table 3B] and [Table 3C] below.

TABLE 3A

| | Invention | Invention |
|---|---|---|
| | Sample 10 [%] | Sample 11 [%] |
| Mycoprotein | 10.71 | 10.72 |
| source | | |
| Water | 84.88 | 84.95 |
| Sugar | 0.96 | 0.96 |
| Salt | 0.10 | 0.00 |
| Flavour | 0.48 | 0.48 |
| Oil | 2.87 | 2.87 |
| High acyl gellan | 0.02 | 0.02 |
| gum¹⁾ | | |
| Guar gum¹⁾ | 0.00 | 0.00 |
| Low acyl gellan | 0.00 | 0.00 |
| gum¹⁾ | | |
| Gum acacia¹⁾ | 0.00 | 0.00 |
| Total | 100.00 | 100.00 |

¹⁾Origin: Special Ingredients, Chesterfield, UK

TABLE 3B

| | Comparative | Comparative | Comparative | Comparative |
|---|---|---|---|---|
| | Sample 12 | Sample 13 | Sample 14 | Sample 15 |
| | [%] | [%] | [%] | [%] |
| Mycoprotein | 10.70 | 10.70 | 10.72 | 10.72 |
| source | | | | |
| Water | 84.87 | 84.87 | 84.95 | 84.95 |
| Sugar | 0.96 | 0.96 | 0.96 | 0.96 |
| Salt | 0.10 | 0.10 | 0.00 | 0.00 |
| Flavour | 0.48 | 0.48 | 0.48 | 0.48 |
| Oil | 2.87 | 2.87 | 2.87 | 2.87 |
| High acyl | 0.00 | 0.00 | 0.00 | 0.00 |
| gellan gum¹⁾ | | | | |
| Guar gum¹⁾ | 0.02 | 0.00 | 0.02 | 0.00 |
| Low acyl | 0.00 | 0.02 | 0.00 | 0.02 |
| gellan gum¹⁾ | | | | |
| Gum | 0.00 | 0.00 | 0.00 | 0.00 |
| acacia¹⁾ | | | | |
| Total | 100.00 | 100.00 | 100.00 | 100.00 |

2) Origin: Special Ingredients, Chesterfield, UK

TABLE 3C

| | Comparative | Comparative | Comparative |
|---|---|---|---|
| | Sample 16 | Sample 17 | Sample 18 |
| | [%] | [%] | [%] |
| Mycoprotein | 10.72 | 10.71 | 10.76 |
| source | | | |
| Water | 84.98 | 84.89 | 85.28 |
| Sugar | 0.96 | 0.96 | 0.96 |
| Salt | 0.00 | 0.10 | 0.10 |
| Flavour | 0.48 | 0.48 | 2.88 |
| Oil | 2.87 | 2.87 | 0.00 |
| High acyl | 0.00 | 0.00 | 0.00 |
| gellan gum¹⁾ | | | |
| Guar gum¹⁾ | 0.00 | 0.00 | 0.00 |
| Low acyl | 0.00 | 0.00 | 0.00 |
| gellan gum¹⁾ | | | |
| Gum | 0.00 | 0.00 | 0.02 |
| acacia¹⁾ | | | |
| Total | 100.00 | 100.00 | 100.00 |

3) Origin: Special Ingredients, Chesterfield, UK

The mycoprotein was provided in the form of wet biomass of Fusarium venenatum pre-washed and was added to water, premixed by hand, and then with a stick blender or food blender. The liquid other ingredients (i.e. the liquid flavour, and when present, the oil) were added and blended using the sick blender or food blender until a smooth dispersion is obtained (about 60s). The other ingredients in solid form (i.e. the sugar, salt and the stabiliser (i.e. high acyl gellan gum, guar gum, low acyl gellan gum or gum acacia) were sprinkled and premixed using the stick blender or food blender until fully dispersed (about 60s).

The microfluidiser was cleaned, sanitised, primed with water, then the other ingredients were introduced into the receptacle. The pressure was set to 3500 psi and the product was passed once. The microfluidiser effluent was heated in a pan on a hob to a temperature of at least 80° C. and then cooled rapidly by pouring into a second container in a cold water bath. When a temperature of less than 40° was reached, the product was microfluidised a second time at a pressure of 3500 psi. The effluent samples were filled into containers and placed in the fridge.

### Example 4: Comparison of the Properties of the Samples Prepared in Example 1 (Invention and Comparative)

The particle size was measured using a Beckman particle analyser (LS13 320, UK) using laser diffraction technique. A volume of 1-2 mL of emulsion samples was added to the measuring chamber. D4,3 was measured automatically by the instrument applying the Mie theory.

The zeta potential was measured using Lightsizer 500 (Anton Paar, Austria). Samples were injected to the zeta potential (OMEGA) cuvettes using a syringe and zeta potential was measured using the theory of Electrophoretic Light Scattering (ELS). Temperature of the measurements was set at 20° C.

The viscosity was measured using a controlled stress rheometer (Anton Paar, Austria) using a parallel plate geometry. Temperature was set at 20° C. Around 3 mL of the samples were pipetted on the rheometer's cell. The gap was set as 1 mm.

The physical stability of each sample was also assessed. The formulations were let to stand at a temperature of 5° C. for 2 hours and the presence of sedimentation was assessed visually.

Furthermore, physical stability of each sample in coffee was assessed. Each samples was added to freshly prepared warm coffee and the absence of splitting was assessed visually.

All results are provided in [Table 4A], [Table 4B] and [Table 4C] below.

TABLE 4A

| | Invention | Invention |
|---|---|---|
| | Sample 10 [%] | Sample 11 [%] |
| Viscosity [cP] | 83.7 | 115.3 |
| Zeta potential | −16.50 | −15.90 |
| [mV] | | |
| Particle size [μm] | 16.87 | 13.24 |
| Sedimentation | NO | NO |
| Split in coffee | NO | NO |

TABLE 4B

| | Comparative | Comparative | Comparative | Comparative |
|---|---|---|---|---|
| | Sample 12 | Sample 13 | Sample 14 | Sample 15 |
| | [%] | [%] | [%] | [%] |
| Viscosity [cP] | 10.9 | 56.8 | 9.3 | 44.1 |
| Zeta potential | −13.70 | −15.20 | −14.50 | −17.60 |
| [mV] | | | | |
| Particle size | 13.33 | 12.79 | 13.68 | 13.69 |
| [μm] | | | | |
| Sedimentation | YES | YES | YES | SLIGHT |
| Split in coffee | NO | YES | NO | YES |

TABLE 2C

| | Comparative | Comparative | Comparative |
|---|---|---|---|
| | Sample 16 | Sample 17 | Sample 18 |
| | [%] | [%] | [%] |
| Viscosity [cP] | 8.8 | 13.0 | 10.7 |
| Zeta potential | −16.90 | −20.40 | −13.80 |
| [mV] | | | |
| Particle size [μm] | 14.42 | 12.76 | 13.56 |
| Sedimentation | YES | YES | YES |
| Split in coffee | NO | NO | NO |

### Discussion of the Results

It is apparent from these results that, among the four stabilisers tested (high acyl gellan gum, low acyl gellan gum, guar gum and gum acacia), only high acyl gellan gum (used in the samples of the invention) was able to prevent sedimentation of the product. Both samples containing high acyl gellan gum were also stable in coffee. Importantly, only one of the available types of gellan gum achieves physical stability and prevents sedimentation, as high acyl gellan gum provided a stable product, in contrast with low acyl gellan gum, which sedimented within 2 hours. Also, high acyl gellan gum did not split in coffee, whereas low acyl gellan gum did split. Thus, the specific structure of high acyl gellan gum is believed to be particularly effective in stabilising the dairy substitute of the present invention.

The viscosity of the samples produced with high acyl gellan gum was also significantly higher than in all other samples, thus providing a particularly advantageous texture to the product.

Besides these aspects, the different samples exhibited substantially similar particle size and zeta potential.

The present results also show that the samples of the invention are physically stable and do not split in coffee, irrespective of the present of salt in the composition, suggesting that salt does not play a role in the stabilisation of the composition. Thus, the dairy substitute of the invention can be formulated with salt, for example as a taste enhancer, with no adverse effect on physical stability. The viscosity of the sample of the invention comprising salt in addition to high acyl gellan gum exhibits a slightly lower viscosity than the sample with salt, but such viscosity remains much higher than that comparative samples containing other stabilisers.

1. A dairy substitute comprising mycoprotein, water, and high acyl gellan gum.

2. The dairy substitute according to claim 1, wherein the high acyl gellan gum is present in an amount of 0.005 to 0.075 wt %, based on the total weight of the dairy substitute.

3. The dairy substitute according to claim 1, wherein the mycoprotein is of filamentous fungus or a fungal mycelium origin.

4. The dairy substitute according to claim 3, wherein the filamentous fungus or a fungal mycelium is a Fusarium.

5. The dairy substitute according to claim 1, wherein said dairy substitute further comprises an oil and optionally an emulsifier.

6. The dairy substitute according to claim 5, wherein the oil is present in an amount of up to 3.5 wt %, based on the total weight of the dairy substitute and wherein the emulsifier is present in an amount of 0.025 to 0.2 wt %, based on the total weight of the dairy substitute.

7. The dairy substituted according to claim 5, wherein said dairy substitute is a milk substitute characterized by a high acyl gellan gum content of 0.005 to 0.02 wt %, by an oil content of up to 2 wt %, and/or by an emulsifier content of 0.025 to 0.1 wt %, based on the total weight of the milk substitute.

8. The dairy substituted according to claim 5, wherein said dairy substitute is a cream substitute characterized by a high acyl gellan gum content of 0.015 to 0.075 wt %, by an oil content of 1 to 3.5 wt %, and/or by an emulsifier content of 0.075 to 0.2 wt %, based on the total weight of the cream substitute.

9. The dairy substituted according to claim 5, wherein said dairy substitute is a yogurt substitute wherein the content of the high acyl gellan gum is of 0.015 to 0.075 wt %, based on the total weight of the yogurt substitute and wherein the emulsifier comprises mono- and di-glycerides.

10. The dairy substitute according to claim 9, wherein the yogurt substitute comprises oil in an amount of up to 2 wt % based on the total weight of the yogurt substitute and/or wherein the emulsifier is present in an amount of 0.025 to 0.1 wt %, based on the total weight of the yogurt substitute.

11. A process for producing a dairy substitute comprising:
a) providing a mycoprotein source;
b) creating a slurry by dispersing the mycoprotein source in water and mixing until the slurry is uniform in consistency and fully dispersed, with no lumps visible to the naked eye;
c) adding high acyl gellan gum;
d) subjecting the mixture obtained at the end of step c) to a microfluidization or homogenization step at a constant pressure of less than 10000 psi; and
e) activating high acyl gellan gum by heating the slurry to at least 72° C.;
f) subjecting the mixture to a second microfluidization or homogenization step at a constant pressure of less than 10000 psi; and
g) optionally pasteurizing the composition obtained at the end of step d).

12. The process according to claim 11, wherein the microfluidization or high-pressure homogenization step is performed at a constant pressure of 1000 to 8000 psi.

13. (canceled)

14. A dairy substitute obtained or obtainable by the process of claim 11.

15. A food product comprising a dairy substitute according to claim 1 or a food product derived from a dairy substitute according to claim 1.

16. The dairy substitute according to claim 3, wherein the filamentous fungus or fungal mycelium belongs to a division selected from the group consisting of Blastocladiomycota, Chytridiomycota, Glomeromycota, Microsporidia, Neocallimastigomycota, Dikarya, Ascomycota, Pezizomycotina, Saccharomycotina, Taphrinomycotina, Basidiomycota, Agaricomycotina, Pucciniomycotina, Ustilaginomycotina, Entomophthoromycotina, Mucor, and Kickomycotina,

17. The dairy substitute according to claim 3, wherein the filamentous fungus or fungal mycelium belongs to a family selected from the group consisting of Mucoraceae, Ustilaginaceae, Hericiaceae, Polyporaceae, Grifolaceae, Lyophyllaceae, Strophariaceae, Lycoperdaceae, Agaricaceae, Pleurotaceae, Physalacriaceae, Omphalotaceae, Tuberaceae, Morchellaceae, Sparassidaceae, Nectriaceae, Bionectriaceae, Cordycipitaceae, Incertomyae, Meruliaceae, Entolomataceae, Nidulariaceae, Fomitopsidaceae, Phanerochaetaceae, and Mycenaceae.

18. The dairy substitute according to claim 3, wherein the filamentous fungus or fungal mycelium belongs to a genus selected from the group consisting of Rhizopus, Ustilago, Hericululm, Polyporous, Grifola, Hypsizygus, Calocybe, Pholiota, Calvatia, Agaricus, Stropharia, Hypholoma, Pleurotus, Tuber, Morchella, Sparassis, Fusarium, Disciotis, Clonostachys, Cordyceps, Trametes, Ganoderma, Flammulina, Lentinula, Lucoagaricus, Bjerkandera, Clitopilus, Cyathus, Ischnoderma, Kuehneromyces, Letinula, Lentinus, Macrofungus, Marasmius, Nidula, Ossicaulis, Phanerochaetes, Ossicaulis, Panellus, Postia, Pycnoporus, Tyromyces, and Wolfiporia.

19. The dairy substitute according to claim 3, wherein the filamentous fungus or fungal mycelium belongs to a species selected from the group consisting of Rhizopus oligosporus, Ustilago esculenta, Hericululm erinaceus, Polyporous squamosus, Polyporus melanopus, Grifola fondrosa, Hypsizygus marmoreus, Hypsizygus ulmarius, Calocybe gambosa, Pholiota nameko, Calvatia gigantea, Agaricus bisporus, Stropharia rugosoannulata, Hypholoma lateritium, Hypholoma capnoides, Pleurotus eryngii, Pleurotus ostreatus, Pleurotus citrinopiheatus, Pleurotus ostreatus, var. Columbinus, Pleurotus djamor roseus, Pleurotus sapidus, Pleurotus sp. florida, Tuber borchii, Morchella esculenta, Morchella conica, Morchella importuna, Sparassis crispa, Fusarium venenatum, Fusarium oxysporum, Disciotis venosa, Clonostachys rosea, Cordyceps militaris, Trametes versicolor, Ganoderma lucidum, Ganoderma applanatum, Flammulina velutipes, Lentinula edodes, Pleurotus djamor, Pleurotus ostreatus, Lucoagaricus spp., Bjerkandera adusta, Clitopilus passeckerianus, Cyathus helenae, Ischnoderma benzoinum, Kuehneromyces mutabilis, Letinula edodes, Lentinus squarrosulus, Macrofungus cohortalis, Marasmius scorodonius, Marasmius scorodonius, Nidula niveo-tomentosa, Phanerochaete chrysosporium, Ossicaulis lignatilis, Panellus serotinus, Postia caesia, Pycnoporus sanguineus, Tyromyces chioneus, and Wolfiporia cocos.

20. The dairy substitute according to claim 3, wherein the filamentous fungus or fungal mycelium is Fusarium venenatum.

21. The dairy substitute according to claim 5, wherein the emulsifier is selected from the group consisting of lecithin and mono- and di-saccharides.
